(19) United States
(12) Patent Application Publication
(10) Pub. No.: US 2008/0270519 A1
(43) Pub. Date: Oct. 30, 2008

(54) Method in a Communication Network for Distributing Vehicle Driving Information and System Implementing the Method

(76) Inventors: Hans Ekdahl, Bromma (SE); Anders S. Nilsson, Hagersten (SE); Johan Gothe, Helsingborg (SE)

Correspondence Address: HARNESS, DICKEY & PIERCE, P.L.C., P.O. BOX 8910, RESTON, VA, 20195, US

(21) Appl. No.: 11/587,596

(22) PCT Filed: May 12, 2005
(86) PCT No.: PCT/SE2005/000685

§ 371 Date: Jun. 5, 2008

(30) Foreign Application Priority Data
May 12, 2004 (SE) 0401226-6

(51) Int. Cl. G06F 15/16; G06F 17/00

(52) U.S. Cl. 709/203; 701/35

(57) ABSTRACT

A method for distributing vehicle driving information comprises: receiving from each of different users of vehicles (n−1, n, n+1) information (iₙ₋₁, iₙ, iₙ₊₁) regarding the driving by the user as sensed by sensors (sₙ₋₁,sₙ, sₙ₊₁) mounted in the vehicle; storing each of the information; and giving access or transmitting to each of several service providers (N−1, N, N+1) a different portion (p_{n-1,n-1}p_{n-1, N} p_{n-1, N+1′} p_{n, N-1} p_{n, N′}p_{n, N+1′}p_{n+1, N-1′}p_{n+1,N+1}) of the stored information at a selected repetition rate. Each of the service providers (N−1, N, N+1) has obtained an authorization (aₙ₋₁ a_{n,N},a_{n, N+1}) provided voluntarily by each one of the users to access the information in return for providing the user with feedback (f_{n, N-1}, f_{n,N},f_{n, N+1}) regarding the driving by the user, where each of the information includes information regarding speed and acceleration of the vehicle, and the feedback includes information as to how to lower the fuel consumption.

### FIELD OF THE INVENTION

The invention relates generally to the distribution of vehicle driving information over a communication network.

### BACKGROUND OF THE INVENTION AND RELATED ART

Tracking systems that can pinpoint a vehicle's location down to a few meters with the help of global positioning system (GPS) satellites are now commonplace and can help suppliers monitor the progress of deliveries and increase efficiency in the supply chain. New automated monitoring systems, which are much like the black-box recorders found in aircraft, go one step further. As well as delivering a constant stream of data detailing each vehicle's speed and location, they can provide diagnostic information on engine and driving performance, which can then be transmitted wirelessly to engineers working remotely.

A vehicle monitoring system comprises an in-vehicle monitoring device and a communications network to send data to a central hub where a customized software system sifts through all the facts and figures. If a lorry ever crashes en route, its monitoring system will be able to take a snapshot of the state of the vehicle at the point of collision—its speed, acceleration, skidding distance and position on the road. Within seconds, it will transmit all that information over a wireless link to customers, hauliers, insurance companies, government road safety statisticians, emergency services—anyone signed up to receive it.

Fleet management products will be able to do even more as wireless networks upgrade around the world. Widespread third-generation wireless access could open the door to everything from downloadable maps and customized weather reports to always-on video monitoring of loads.

A known technology called ISA (Intelligent Speed Adaption), see e.g. information on the Internet site http://www.isa.vv.se available on May 7, 2004, facilitates to keep the speed limit. A small in-vehicle mounted device unit displays continuously the current speed limit by using GPS technology and referring to a road database containing information of road specific speed limit information. As soon as the speed limit is exceeded an alarm signal is sent out or an intelligent accelerator pedal makes resistance when one intends to drive faster than the current speed limit.

U.S. Pat. No. 6,711,495 B1 discloses a method of gathering and analyzing vehicle information. A central vehicle-information management center gathers first vehicle information gathered in real time, including position of the vehicle, control of vehicle, and conditions of vehicle parts, and gathers second vehicle information including vehicle type, vehicle identification number, and information regarding users of the vehicles. The central vehicle information management center performs a statistical analysis for the plurality of vehicles based on the first and second information. The first information is transmitted by a transmitter provided on each vehicle, and acquired via a satellite communication system and/or a land-based wireless communication system.

US 2002/0111725 A1 discloses a computer system that accepts and stores information from subscribers of vehicle communication systems. This information includes information about vehicle drivers, the vehicle and scored data that represents the operational characteristics of the vehicle that has been obtained from vehicle sensors and transmitted through the vehicle communication system. Captured sensor data is processed and presented through a standardized scoring system to protect driver privacy, provide a means for assessing and measuring relative driver safety and to facilitate the offering of insurance discounts by insurance companies. The invention further provides a mechanism for vehicle owners to obtain lower insurance rates based on scored safety-related data and for insurance companies to obtain new insurance subscribers and to provide them insurance discounts based on scored safety-related data.

### SUMMARY OF THE INVENTION

The inventors of the present invention have, however, noticed several drawbacks or shortcomings with the prior art disclosed above.

All prior art fleet management products suffer from being expensive, and having a restricted or limited use, i.e. they are each devoted to a single application, e.g. position tracking, or speed limitation or something else.

Many products are technology driven, rather than driven by the market and customer needs. Their wider spreading is limited since they often provide a limited value for the user.

Further, some of the products rely on forcing the driver to reach the aim of the product, e.g. forcing a driver to reduce the speed by using an accelerator, which makes resistance. Other products may not be accepted by the customers since they feel controlled and supervised.

U.S. Pat. No. 6,711,495 B1 and US 2002/0111725 A1 fail to disclose that feedback to the driver may include information as to how to change the driving to obtain lower fuel consumption. U.S. Pat. No. 6,711,495 B1 fails also to disclose that the information regarding the driving by the user of the vehicle as received includes information regarding speed and acceleration of the vehicle,

Further, both solutions seem to be restricted to a single application such as e.g. position determination or speed limitation. Also, they may be of limited value to the users of the vehicles.

The systems disclosed in U.S. Pat. No. 6,711,495 B1 and US 2002/0111725 A1 are not utilizing network resources, the available radio frequency spectrum, or the available bandwidth optimally. Finally, the above systems do not lead to reduced fuel costs, reduced use of fossil fuels, or less environmental damages.

An aim of the invention is therefore to provide a method and a system, respectively, for distributing vehicle driving information, which overcome the drawbacks and shortcomings associated with the prior art.

In this respect there are particular aims of the invention to provide such a method and such a system, which are fairly simple and inexpensive, and which can be used for distributing vehicle driving information for many different purposes, i.e. forwarding driving information to many service providers, which can supply users of vehicles using the invention with valuable feedback, incentives, and/or information.

There is a further aim of the invention to provide such a method and such a system, which make use of authorizations to distribute information in a voluntary and controlled manner, in order to obtain data security and integrity.

There is still a further aim of the invention to provide such a method and such a system, which reduces the fuel consumption and/or the risk of causing a traffic accident for each of the vehicles using the invention. Provided that a large number of vehicles make use of the invention the fuel consumption and the number of traffic accidents can be reduced on a global level.

There is yet a further aim of the invention to provide such a method and such a system, which provide for optimum utilization of equipment, network resources, available radio frequency spectrum, and bandwidth.

These aims, among others, are attained by methods and systems as claimed in the appended claims.

Further characteristics of the invention and advantages thereof, will be evident from the detailed description of the present invention given hereinafter and the accompanying FIGS. 1-4, which are given by way of illustration only, and thus, are not limitative of the present invention.

### BRIEF DESCRIPTION OF THE DRAWINGS

FIG. 1 illustrates schematically a system for distributing vehicle driving information according the invention.

FIG. 2 illustrates schematically a drive recorder for use in the system of FIG. 1.

FIG. 3 is a matrix of net moment, fuel flow and number of revolutions as used in a particular embodiment of the invention.

FIG. 4 is a block diagram illustrating how feedback can influence the behavior of the driver as used in an embodiment of the present invention.

### DESCRIPTION OF EMBODIMENTS OF THE INVENTION

So far most efforts to reduce accidents have been directed towards safer cars and better roads. However if also the driving behavior can be improved by better feed back to driver and incentives to drive with care, there are big potentials for:
Fewer accidents and thus accident related costs
Reduced fuel costs
Reduced CO₂ and NO emissions
Reduced Running costs for tires, service and repair

The present invention provides for smart driving based on better feed back to drivers to reduce accidents as well as improve the cost of running the vehicle.

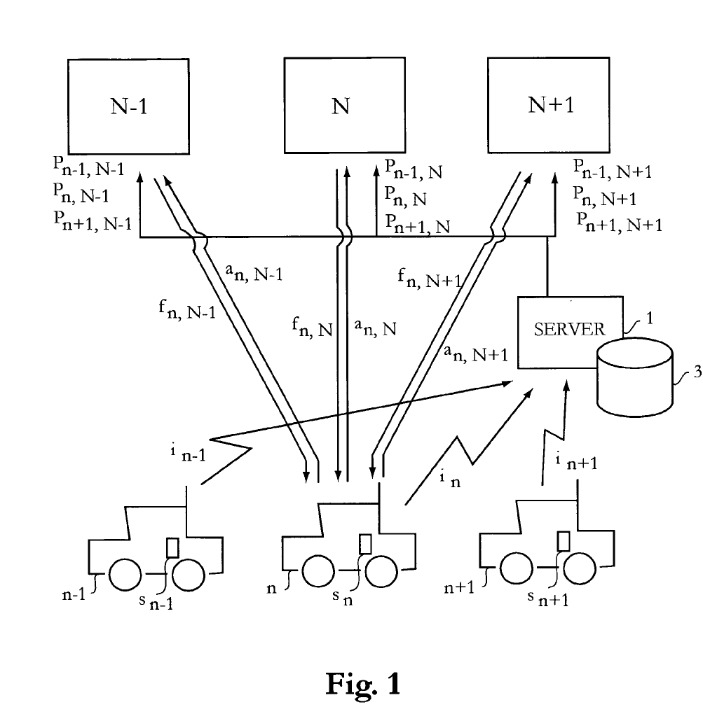

The inventive system, schematically illustrated in FIG. 1, comprises a server 1 connected to a plurality of clients or users n−1, n, n+1 in a wireless communication network.

The server 1, being referred to as a VDI (voluntary driving information) VDI server, comprises or is connected to a database 3. Further, the VDI server 1 is via the wireless communication network, via another wireless communication network, or via a wired communications network, such as the Internet, connected to a plurality of service providers N−1, N, N+1. Each of the service providers N−1, N, N+1 may e.g. be any of an insurance company, an emergency call center, a service workshop, a position-dependent information provider, a driving training center, or a vehicle manufacturer. Of course, the server 1 may also operate as a service provider.

The clients n−1, n, n+1 are each comprised of a vehicle, such as e.g. a car, truck, trailer, vessel, boat etc., equipped with a wireless transmitter, such as e.g. a cellular telephone, a PDA (personal digital assistant), or a fixedly mounted cellular transmitter device, a processor/storage device, and a drive recorder sₙ₋₁, sₙ, sₙ₊₁ connected to each other.

Each of the drive recorders sₙ₋₁, sₙ, sₙ₊₁ comprises a plurality of sensors for sensing the driving of a user of the vehicle, and includes e.g. a GPS sensor or other positioning device for sensing the position of the vehicle, a speedometer for sensing the speed of the vehicle, an acceleration sensor for sensing the acceleration and retardation of the vehicle, a clock for measuring time, etc. Some sensors may be located at different locations of the vehicle for sensing various parameters, and be connected to the drive recorder.

The transmitter device of each of the vehicles n−1, n, n+1 is configured to automatically and repeatedly transmit over the wireless communication network information iₙ₋₁, iₙ, iₙ₊₁ regarding the driving performed by the user of the vehicle as sensed by the plurality of sensors sₙ₋₁, sₙ, sₙ₊₁ mounted in the vehicle.

The VDI server 1 receives each of the information iₙ₋₁, iₙ, iₙ₊₁ and stores it automatically and repeatedly in the database 3. Preferably, the VDI server 1 processes the information e.g. statistically. Then, the VDI server 1 gives access or transmits to each one of the plurality of service providers N−1, N, N+1 a selected portion p_{n-1,N-1} p_{n-1,N} p_{n-1,N+1}, p_{n,N-1} p_{n,N}, p_{n,N+1}, p_{n+1,N-1}, p_{n+1,N}, p_{n+1,N+1} of each one of the automatically and repeatedly stored information, i.e. the VDI server 1 transmits the portion P_{n-1,N-1} of the information iₙ₋₁ received from the vehicle n−1 to the service provider N−1, the portion p_{n-1,N} of the information iₙ₋₁ received from the vehicle n−1 to the service provider N, the portion p_{n-1,N+1} of the information iₙ₋₁ received from the vehicle n−1 to the service provider N+1, the portion p_{n,N-1} of the information iₙ received from the vehicle n to the service provider N−1, etc.

Each of the service providers N−1, N, N+1 has in advance obtained an authorization a_{n,N-1} a_{n,N}, a_{n,N+1} from each of the users to access the respective selected portion of the automatically and repeatedly stored information in return for providing the user of the vehicle n−1, n, n+1 with feedback f_{n,N-1} f_{n,N}, f_{n,N+1} regarding the driving or handling of the vehicle. For sake of simplicity, only the authorizations from and feedback to the vehicle n are indicated in FIG. 1. The authorizations a_{n,N-1} a_{n,N}, a_{n,N+1} are provided voluntarily by each of the users. The feedback may instead be given by the server 1.

The term “user of a vehicle” as used throughout the present text should be understood as a broad term including the physical driver and the owner of the vehicle, and other persons that handle the vehicle, as well as legal persons owning or using the vehicle, e.g. transportation companies and car rental and leasing companies.

The term “driving information” and “feedback regarding the driving” may include information regarding the driving and function of the vehicle, information regarding the driving behaviour of the driver of the vehicle, and information regarding the surroundings of the vehicle such as distance to the vehicle in front, outside temperature, and other weather conditions.

The feedback regarding the driving performed by the user may preferably be determined based on processing the selected portion of the automatically and repeatedly stored information received by the service provider, and by comparing the processed information with information regarding the driving performed by other users, e.g. a mean value, or by comparing it with a model information retrieved from the driving of a model user. There are various different approaches known in the literature on how to process driving data to find feedback in the form of recommendations on how to change the driving behaviour in order to improve the driving, see e.g. research results on the Internet site http://www.skogforsk.se available on May 7, 2004.

Note that the system for distributing vehicle driving information as described above may be part of a much larger system, wherein the VDI server 1 does not give access or transmit to each one of the service providers a selected portion of each one of the automatically and repeatedly stored information, but gives access or transmits to some, e.g. at least two, of the service providers a selected portion of some, i.e. at least two, of the automatically and repeatedly stored information. Similarly, only some of the service providers have obtained an authorization in advance from some of the users to access the respective selected portion of the automatically and repeatedly stored information in return for providing the user of the vehicle with feedback regarding the driving or handling of the vehicle. Thus, it shall be understood that information from a user is forwarded to the VDI server, and that selected but overlapping portions of this information are made accessible or transmitted to two service providers at the minimum to obtain sharing of information among service providers.

The number of vehicles connected in the VDI network may be several thousands, or many more, whereas the number of service providers connected to the VDI server 1 is at least two, preferably at least five, more preferably at least ten, and most preferably at least twenty. Typically, each of the users has authorized only a selected subgroup of the service providers to access a respective selected portion of the automatically and repeatedly stored information from that user.

Different parts of each of the information iₙ₋₁, iₙ, iₙ₊₁ regarding the driving by the user of the respective vehicle may be transmitted to the VDI server at selected, and preferably different, repetition rates depending on the nature of the respective information iₙ₋₁, iₙ, iₙ₊₁. For instance, information regarding the position of the respective vehicle may be transmitted to the VDI server at a high frequency, whereas other information such as information regarding the driving behaviour may be stored and optionally processed by the processor/storage device in the respective vehicle. Other information parts are transmitted at times triggered by some event, e.g. an error code can be transmitted to the VDI server (and then directly forwarded to a service workshop) at the point of time the error is found. Similarly, emergency information may be transmitted as soon as the emergency situation occurs.

Similarly, the selected portions p_{n-1,N-1} p_{n-1,N} p_{n-1,N+1}, p_{n,N-1} p_{n,N}, p_{n,N+1}, p_{n+1,N-1}, p_{n+1,N}, p_{n+1,N+1} of each of the automatically and repeatedly stored information are made available or transmitted to different ones of the plurality of service providers N−1, N, N+1 at different repetition rates. These transmissions may be performed on regular or irregular basis, and they may be triggered by requests from the service providers, or from the users. For instance, information of an accident has to be forwarded by the VDI server 1 to an authorized emergency call center immediately, whereas selected information to an insurance company may be transferred regularly more rarely, e.g. once a month.

Generally, each part of information is transmitted to the VDI server 1 and each portion of information made available or transmitted to each service provider follow a predefined rule based scheme.

Further, the selected portions p_{n-1,N-1} p_{n-1,N} p_{n-1,N+1}, p_{n,N-1} p_{n,N}, p_{n,N+1}, p_{n+1,N-1}, p_{n+1,N}, p_{n+1,N+1} of each of the automatically and repeatedly stored information transmitted to the plurality of service providers N−1, N, N+1 may be different. For instance an insurance company, an emergency call center, and a service workshop are interested in quite different kind of information.

The present invention thus provides for an effective use of hardware, software and network utility. A large number of service providers receive selected information from the users of the vehicles to their use. In return the users are provided with incentives, feedback, rewards or information. Only a single transmitter device and a single drive recorder are needed for each vehicle to obtain and transmit to the VDI server multipurpose information, selected portions of which being directed to various service providers, i.e. the transmitter device and the drive recorder of the vehicle are together with the VDI server used to share information among the various service providers.

An authorization contract is set up between the user of each vehicle and each service provider that is to obtain selected information from that vehicle. By signing the contract (which specify the kind of selected information which is to be obtained, and optionally when this information is to be obtained, as well as the kind of feedback or reward which the user is to expect) the corresponding service provider obtains an authorization to access the selected information in return for providing the user of the vehicle with the feedback or the reward. This provides for a safe system, wherein access to information is limited to that agreed upon.

The invention relies on the assumption that the user/driver has responsibility for his driving behaviour. By giving the driver/user motivation and incentives for good driving fuel consumption, emissions, and the rate of accidents will be reduced.

Some of the information regarding the driving performed by the user of the vehicle as sensed by the plurality of sensors includes preferably information regarding speed, acceleration and retardation of the vehicle, and the feedback regarding the driving of the vehicle includes preferably information as to how to change the driving to obtain lower fuel consumption.

Alternatively or additionally, some of the information regarding the driving performed by the user of the vehicle as sensed by the plurality of sensors includes information regarding speed, acceleration and retardation of the vehicle, and the feedback regarding the driving of the vehicle includes information as to how to change the driving behaviour to reduce the risk of causing a traffic accident.

Generally, the invention is not limited to particular kind of drive recorders and sensors mounted in the vehicles, to particular kind of information regarding the driving by the user of the vehicle, to particular kind of service providers, or to particular kind of feedback regarding the driving of the vehicle, or rewards received by the user in return for signing the contract with the service provider. However, a few non-limiting examples are given below.

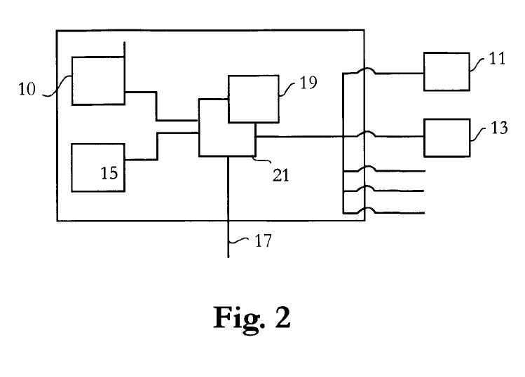

The main function of the in-vehicle mounted drive recorder, schematically illustrated in FIG. 2, is to log data about how the vehicle has been driven, and to forward this data to the VDI server. To this end, the drive recorder may be connected to or comprise a transmitter or transceiver 10 and a number of different sensors such e.g. a road condition sensor 11, a tyre pressure sensor 13, and a GPS device 15, etc. Furthermore, the drive recorder has an interface, wired or wireless via e.g. Bluetooth to CAN-bus 17 to log data from there. The CAN-is capable of retrieving:
Actual vehicle speed
Total distance of the vehicle during life
Actual fuel consumption
Total fuel consumption during vehicle life
Tachograph speed
Tachograph driver knobs status
Tachograph warnings of exceeding drive time deregulations
Tachograph overreving and direction indicator
Vehicle Identification number
Brake Switch
Cruise Control status
Clutch switch
PTO (power take off) on/off
Throttle position
Axle weight and position
Total running hours
Next regular maintenance
Engine temperature

The drive recorder is preferably provided with a storage device 19 and optionally a processor 21. An anti-theft identification system may be provided, which authorizes the user of the vehicle, and prevents that the vehicle is identified as stolen.

The drive recorder is preferably an inexpensive simple device provided with or connectable to a transceiver device such as mobile phone. Preferably, the drive recorder is controlled remotely for instance from the VDI server.

Service providers may include:
Insurance companies who rewards drivers who drive with care
Insurance companies who get lower insurance costs by a better chance to trace stolen vehicles
Leasing and rental companies who differentiate the rate dependent on the manner the vehicle has been driven
Department of main roads which wants to reduce the number of accidents and give a discount on the road tax for drivers who voluntarily drive with care
Service workshops who can trace error codes
Buyers of trade in cars/trucks who pay better for vehicles with a good driving history
Alarm centrals and owners, who can trace the vehicle when it has been stolen
The police who get a chance to fight crime by getting the GPS position of stolen cars or trucks
Driving training centers who can learn the drivers how to improve their driving
Manufacturers of vehicles who can learn how their vehicles are used and thereby improve the quality of their vehicles

A particular service that may be incorporated in the invention is a navigation support system with voice directions. Assume that the vehicle is equipped with a wireless communication unit such as a mobile phone and a GPS for positioning of the vehicle. Assume also that there is a map and navigation system available at a call center. At a predefined limit he directs the call center to give him driving directions by voice in his ordinary mobile phone.

The navigation support runs as follows. The driver of the vehicle places a call to the call center to describe the address of his destination. The target destination position is defined. The position from which the navigation instructions are required is also defined. The navigation support gives the driver navigation direction automatically over his/her mobile phone. By voice the driver is given directions such as “take right in the next intersection” to guide him/her to the indicated direction.

This map and navigation system can, as an alternative, also be available to the driver allowing him, in advance by web-access, to plan his route.

To give end users and service providers access to information of their entire fleet the central data base may contain a copy of, or have a link to, driving data from the manufacturers' proprietary systems. In this manner the end user is not locked in to a system provided by a vehicle manufacturer. Instead he can get access to information for his entire fleet independent of brand.

The following goals may be met by the present invention:
Reduced fuel consumption
Reduced emissions of NOx and CO₂ and thus better environment
Fewer accidents
Lower traffic insurance costs and repair insurance-costs Less human sufferings due fewer injuries in traffic accidents
Lower crime rate due to the possibility to trace stolen cars
Lower insurance costs due to lower crime rate
Lower vehicle life cycle costs
Lower service and repair costs by stored error codes supporting workshop technicians in the diagnose of errors

A further embodiment of the invention is disclosed below. The embodiment is related to automatic analysis of dimensioning and retrieval of guideline values for the mechanical assumptions.

Description of the Technical Problem that the Embodiment Solves:

To have correctly dimensioned transport vehicles for the kind of transport mission the owner of the vehicle owner has is extremely important. Today, many of the transports are carried out using quite too powerful engines and incorrectly dimensioned rear axles, which is devastating as regards fuel and maintenance costs. There are also great risks of using an undersized vehicle, which radically increases costs for wear and tear. If the vehicle is very undersized, it will not be capable to at all carry out the mission since it is not capable of driving uphill slopes, etc. The problem is to find the optimum choice between fuel cost savings and wear and tear costs.

### Description of the Embodiment:

The system measures the operation needs of the transport and the operation properties of the vehicle. These data is stored in two arrays: operation properties and operation needs. Example of operation properties and operation needs are found below:

| Operation properties | Operation needs |
|---|---|
| Net moment matrix | Moment |
| Rear axle gear | Velocity |
| Transmission, gear box | GPS position |
| Kind of engine | Number of revolutions |
| Kind of vehicle | Fuel flow (consumption) |
| | Time |

These data are transmitted to a central server, e.g. the server 1 in FIG. 1. In the central server these data is shared and the user or owner of the vehicle is given access to operation properties of other transport vehicles.

In the server 1 data regarding transport vehicles and the driving of transport vehicles are processed, operation properties are simulated based on recorded operation needs, and optionally on other information from the vehicles; and optimum operation properties with regard to fuel consumption and vehicle wear and tear are determined for each of the transport vehicles based on the operation needs of that vehicle, and are communicated to the users or owners.

By these provisions, the user or owner of a transport vehicle, the user or owner can get information of other kind of vehicles that had given lower operation costs for a given kind of driving behaviour (i.e. for the driving behaviour of the driver of the transport vehicle) and for a given kind of transport.

By estimating delivered torque on the crankshaft and by comparing it with the heat energy from the fuel, a mechanical energy efficiency can be calculated, i.e. how much of the heat energy that is actually transferred to mechanical energy. By the actual mechanical energy is meant the energy that is delivered by the crankshaft to the driving. The energy needed by external units and accessories such as generators, fuel pump, cooling fan, compressors, etc. is deducted since it is not contributing to the actual transport work. These units give rise to a lower torque curve or zero moment curve, which represents the torque the engine has to deliver to keep all units operating. Hereby the net moment is decreased.

### Maximum Torque on the Crankshaft:

Mₘₐₓ_{_{—}}ₙₑₜ(ω)=Mₘₐₓ(ω)−M_{acc}(ω)

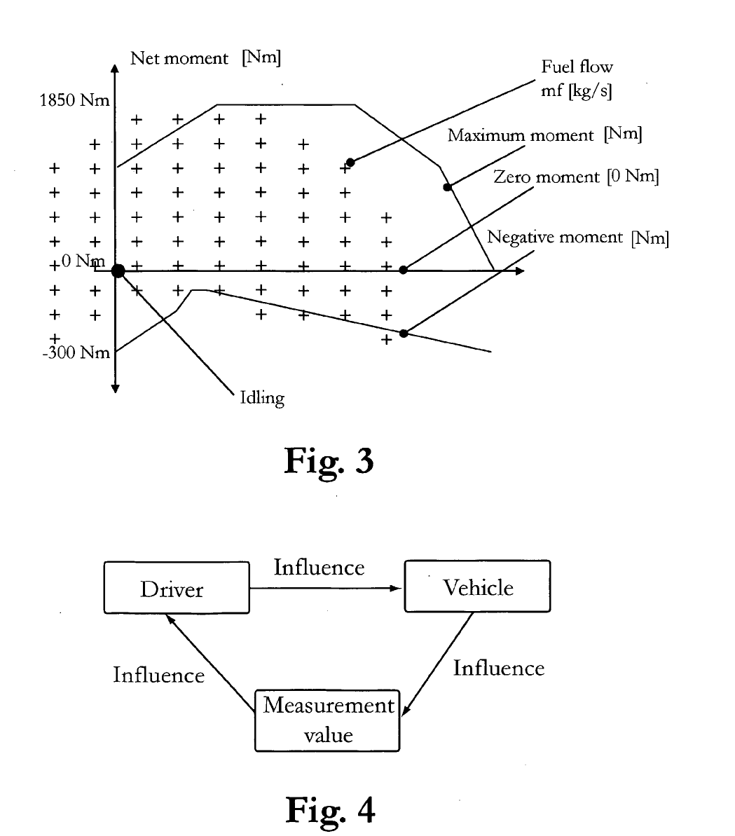

A matrix of the net moment, fuel flow and number of revolutions is formed, see FIG. 3.

By means of measuring the idling fuel consumption, the zero moment curve may be corrected, and thus the complete net moment matrix is corrected. The system thus has an adaptive model for the net moment. This solves a big problem regarding trimming of the system for individual transport vehicles. By summing all energy delivered by the engine at a fuel flow >0 (could be negative) and by comparing the heat energy, a mechanical efficiency for the vehicle is deduced. This efficiency should be as high as possible with regard to the fuel consumption.

The net moment matrices together with logging data (i.e. the other data from the vehicle) are transmitted to the central server, and are later used to simulate other kind of transports from other vehicles in order to calculate an alternative fuel consumption efficiency. Since the central server also collects data regarding maintenance and service costs for the vehicles, conclusions about the efficiency of the transport can be made. Information on how the transport could have been made by another vehicle in order to minimize fuel, operation and maintenance, and service costs is deduced. By using the logging data the risk of under-sizing the vehicle is minimized by having a safety margin regarding the performance of the simulated alternative vehicles.

The system comprises a measuring unit, a driver unit, a communication unit, a GPS and a central data collection unit.

The measuring unit reads information from the computer system of the vehicle and where information is missing senses parameters with sensors. Data needed for calculations comprise velocity, accelerator pedal position, time, brake pedal position, driver identification, height level and position (direction and velocity) for the vehicle.

The driver unit may give a signal to the driver indicating the dimensioning of the vehicle to the transport.

The communication unit transmits data to the central data collection unit, and may receive data from there.

The GPS measures height level and position and deduces velocity and direction.

The central data collection unit, which may be the central server from FIG. 1, or other unit, stores, processes (e.g. statistically); and presents information.

The embodiment may be used in fuel management systems and in vehicle computers.

A further embodiment of the invention is disclosed below. The embodiment is related to automatic evaluation of fuel economy based on the mass of the vehicle.

Description of the technical problem that the embodiment solves:

The costs for transporting a cargo from a point A to a point B depend on several parameters. Some of these are the mass (weight) of the vehicle, the mass (weight) of the cargo and the distance between A and B. Since the vehicle itself has a considerable mass there is an overhead cost, i.e. the mass of the vehicle has to be transported from A to B independently of the mass of the cargo. Therefore, many transporters are intending to optimize fuel consumption per transported cargo mass and length. Cargos having low density may often be rendered more effective by packing the cargo in a smarter manner, e.g. cardboard may be folded. If a low density cargo cannot be compressed, the transporter should transport the cargo using a low weight and low power vehicle to obtain the best fuel economy.

In order to be capable of working with the streamlining the management has to have measurement values to start from. It has been shown to be very difficult to estimate the weight and transported distance of the transported cargo since cargo is unloaded by stages. Therefore, an automatic system is needed.

Vehicles with overweight cargo may also be subjected to high fines. It is very difficult to know if you are loading your vehicle excessively, particularly when loading timber in the woods without having weighing equipment.

### Description of the Embodiment:

Measurements have shown that heavy vehicles in traffic are engine-braking in 10-30% of the distance traveled. While engine-braking, the engine is towed by the change in kinetic and potential energy of the vehicle. By getting knowledge of the properties of the engine, the energy loss due to the engine while engine-braking can be estimated.

### Energy Needed for Towing the Engine

$$\begin{matrix}{E}_{e} = {\int }_{t 0}^{t 1} ( {P}_{e} ( ω ( t ) ) ) & \\ {E}_{e} - Engine energy & [ J ] \\ ω - Engine speed & [ rad \text{/} s ] \\ {P}_{e} - Engine power & [ W ] \\ t - time & [ s ]\end{matrix}$$

### Energy Change Due to Height Level Change

$$\begin{matrix}{M}_{p} = Δ h * g & [ units of mass ] \\ Δ {E}_{p} = m * Δ h * g & \\ Δ {E}_{p} - change in potential energy & [ J ] \\ Δ h - height difference & [ m ] \\ m - vehicle mass & [ kg ]\end{matrix}$$

### Energy Change Due to Velocity Change

$$\begin{matrix}{M}_{k} = ( {v}_{0}^{2} - {v}_{1}^{2} ) / 2 & [ units of mass ] \\ Δ {E}_{k} = m * ( {v}_{0}^{2} - {v}_{1}^{2} ) / 2 & \\ Δ {E}_{k} - change in kinetic energy & [ J ] \\ v 0 - initial road speed & [ m \text{/} s ] \\ v 1 - final road speed & [ m \text{/} s ] \\ m - vehicle mass & [ kg ]\end{matrix}$$

### Energy Loss Due to Air Resistance

$$\begin{matrix}{E}_{d} = {\int }_{t 0}^{t 1} ( d * {A}_{f} * {C}_{d} * {v ( t )}^{2} / 2 ) & \\ {E}_{d} - Work due to air resistance & [ J ] \\ d - air density & [ kg \text{/} {dm}^{3} ] \\ {A}_{f} - front area & [ {m}^{2} ] \\ {C}_{d} - air resistance coefficient & [ - ] \\ v - road speed & [ m \text{/} s ] \\ t - time & [ s ]\end{matrix}$$

### Energy Loss Due to Roll Resistance

$$\begin{matrix}{M}_{r} = {\int }_{t 0}^{t 1} ( {R}_{c} ( v ( t ) ) * v ( t ) ) & [ units of mass ] \\ {E}_{r} = {\int }_{t 0}^{t 1} ( {R}_{c} ( v ( t ) ) * m * v ( t ) ) & \\ {E}_{r} - Work due to roll resistance & [ J ] \\ {R}_{c} - roll resistance coefficient & [ N \text{/} kg ] \\ v - road speed & [ m \text{/} s ] \\ t - time & [ s ] \\ m - vehicle mass & [ kg ] \\ {E}_{r} + {E}_{d} + {E}_{p} + {E}_{k} + {E}_{e} = 0 & \\ {M}_{r} = {E}_{r} / m & \\ {M}_{p} = {E}_{p} / m & \\ {M}_{k} = {E}_{k} / m & \\ {E}_{e} + {E}_{d} + m * ( {M}_{r} + {M}_{p} + {M}_{k} ) = 0 & \\ m = ( - {E}_{e} - {E}_{d} ) / ( {M}_{r} + {M}_{p} + {M}_{k} ) & \end{matrix}$$

When the vehicle starts to engine-braking, the potential and kinetic energy of the vehicle is calculated from height level and velocity from a GPS. The energy is expressed in units of mass, i.e. [J/kg].

During engine-braking the roll resistance is calculated in energy per kg [J/kg], the air resistance and engine-braking resistance are calculated in Joules. Then, the mass of the vehicle is calculated as

m=(−Eₑ−E_{d})/(Mᵣ+Mₚ+Mₖ)

The mass of the vehicle is subtracted from the mass and the cargo weight has been deduced

Cargo mass=m−mass of vehicle

The system comprises a measuring unit, a driver unit, a communication unit, a GPS and a central data collection unit. The measuring unit reads information from the computer system of the vehicle and where information is missing senses parameters with sensors. Data needed for calculations comprise velocity, accelerator pedal position, time, brake pedal position, driver identification, height level and position (direction and velocity) for the vehicle.

The driver unit may give a signal to the driver indicating the cargo weight and estimated brake distance. The unit may also give an alarm if the vehicle is overloaded.

The communication unit transmits data to the central data collection unit, and may receive data from there.

The GPS measures height level and position and deduces velocity and direction.

The central data collection unit, which may be the central server from FIG. 1, or other unit, e.g. mounted in the vehicle, stores, processes, and presents information.

The embodiment may be used in fuel management systems and in vehicle computers.

A further embodiment of the invention is disclosed below. The embodiment is related to Gauffin's algorithm.

Description of the Technical Problem that the Embodiment Solves:

Operation costs for engine-driven vehicles vary tremendously and a large part of the cost variation can be derived to the driver behaviour. Many factors are comprised in the term driver behaviour. The single factor, which probably is most important regarding operation costs, is the capability of planning the driving. Operation costs comprise fuel, wear and tear, repair, and insurance costs. Since the driver behaviour is individual it is indeed quite different. In large groups of drivers with large differences it is today quite difficult, if at all possible, to know who is driving economically and who is not, who is driving safe and who is not. This lack of knowledge is troublesome for fleet management since it does not know how to improve the driving, lower the costs and increase the safety.

The present embodiment of the invention aims at lowering fuel consumption, increase the road safety, lower service and repair costs, and increase the awareness of the drivers.

### Description of the Embodiment:

A proper indicator of a planned driving behaviour is to look on the driver's capability to judge when energy should be supplied to the vehicle (to accelerate or keep the speed) and when energy should be removed from the vehicle (to retard the vehicle). The embodiment calculates the time between acceleration is terminated and braking is started, and uses this time as a driving planning capability parameter. A low value indicates that the driver does not plan the driving very well, whereas a higher value indicates that the planning is better. A very low value indicates an emergency situation with panic braking. The number of low values can pinpoint risky drivers or risky roads.

The system comprises a measuring unit, a driver unit, a communication unit, a GPS and a central data collection unit.

The measuring unit reads information from the computer system of the vehicle and where information is missing senses parameters with sensors. Data needed for calculations comprise velocity, accelerator pedal position, time, brake pedal position, driver identification, height level and position (direction and velocity) for the vehicle.

The driver unit may give a signal to the driver indicating his/her driving planning capability.

The communication unit transmits data to the central data collection unit, and may receive data from there.

The GPS measures height level and position and deduces velocity and direction.

The central data collection unit, which may be the central server from FIG. 1, or other unit, e.g. mounted in the vehicle, stores, processes, and presents information.

The embodiment may be used in fuel management systems and in vehicle computers.

Another indicator to be used may be how fast the accelerator pedal is released, i.e. let up. A high value would indicate bad planning or a sudden event.

In order to save fuel, the driving behaviour of the driver has to be changed. In order to change the driving behaviour, the driver needs some kind of feedback. This feedback may be performed via the central data collection unit, see FIG. 4.

When the driver is given access to his/her indicator value he/she can influence it by planning his/her driving better. A reward may be given to drivers that improve. The measuring unit transmits via the communication unit a new indicator value, which is presented to the driver, and he/she may obtain real time feedback, e.g. a confirmation of an improved driving planning.

The central data collection unit can give feedback in real time and as reflecting feedback afterwards. The real time information can be delivered by smartphone/PDA or similar in connection with the driving. The feedback afterwards may be presented from several drivings of the vehicle, and may be processed before presentation to reveal statistical values and to present a behaviour pattern.

### Traffic Security:

When the indicator indicates a low value indicating that the driver is put into a situation where he/she quickly has to change the supply to or removal of energy from the vehicle. This is indicated as an increased risk. Time, GPS position and the low value are logged and sent to the central data collection unit. When a large number of vehicles have low values in a certain road area, this indicates that the road area may have an increased risk of accidents.

It shall be appreciated that any of the above embodiments of the invention may be combined with any other in order to reach yet further embodiments of the invention. It shall particularly be noted that several of the features of the first disclosed embodiment, such as e.g. (i) voluntary authorization; (ii) feedback, (iii) flexibility regarding what and when to send information, etc., can be comprised in each of the latter disclosed embodiments of the invention. Similarly, the latter disclosed embodiments may be implemented in any kind of fleer management systems, e.g. in any of those disclosed in the prior art section of this text.

1. A method in a communication network for distributing vehicle driving information from a server connected in the communication network, wherein the steps of:
receiving automatically, repeatedly and wirelessly from each one of a plurality of different users of vehicles information regarding the driving by the user of the vehicle as sensed by a plurality of sensors mounted in the vehicle;
storing automatically and repeatedly each one of said information in a database; and
giving access or transmitting to each one of a plurality of service providers a selected portion of said stored information, wherein
different parts of each one of said information are received at selected different repetition rates;
the selected portions of said stored information are different;
the selected portions of said stored information are made accessible or transmitted to different ones of said plurality of service providers at selected different repetition rates;
each one of said service providers has obtained an authorization provided voluntarily by each one of said users to access information regarding the driving by the user in return for providing the user with feedback regarding the driving by the user;
each one of said information regarding the driving by the user of the vehicle as sensed by a plurality of sensors mounted in the vehicle includes information regarding speed and acceleration of the vehicle, and said feedback regarding the driving includes information as to how to change the driving to obtain lower fuel consumption; and
at least one of said service providers is any of a driving training center, an emergency call center, an alarm central, a vehicle manufacturer, a service workshop, a position-dependent information provider, a leasing or a rental company, a road department, or the police.

2. The method of claim 1 wherein at least one of said service providers is a driving training center and said feedback includes information as to how to improve the driving.

3. The method of claim 1 wherein at least one of said service providers is a manufacturer of the vehicle, and said feedback includes information as to how to change the driving to obtain a longer lifetime of the vehicle, or of parts thereof.

4. The method of claim 1 wherein said feedback regarding the driving of the vehicle includes information as to how to change the driving to reduce the risk of causing a traffic accident.

5. The method of claim 1 comprising the steps of:
receiving automatically, repeatedly and wirelessly from each one of a further plurality of different users of vehicles information regarding the driving by the user of the vehicle as sensed by a plurality of sensors mounted in the vehicle;
storing automatically and repeatedly each of said information received from the further plurality of different users in said database;
giving access or transmitting to each one of a subgroup of said plurality of service providers a selected portion of said stored information, wherein
each one of the subgroup of said service providers has obtained an authorization provided voluntarily by each one of said further plurality of different users to access information regarding the driving by the user in return for providing the user with feedback regarding the driving by the user.

6. The method of claim 1 comprising the step of:
giving access or transmitting to each one of a further plurality of service providers a selected portion of said stored information, wherein
each one of a subgroup of said service providers has obtained an authorization provided voluntarily by each one of said plurality of different users to access information regarding the driving by the user in return for providing the user with feedback regarding the driving by the user.

7. A server system for distributing vehicle driving information in a communication network, wherein said server system comprises:
a receiver device provided for receiving automatically, repeatedly and wirelessly from each one of a plurality of different users of vehicles information regarding the driving by the user of the vehicle as sensed by a plurality of sensors mounted in the vehicle;
a device provided for storing automatically and repeatedly each of said information in a database; and
a access-giving or transmitter device provided for giving access or transmitting to each one of a plurality of service providers a selected portion of said stored information, wherein
said receiver device is provided for receiving different parts of each one of said information at selected different repetition rates;
said access-giving or transmitter device is provided for giving access or transmitting to different ones of the plurality of service providers different selected portions of said stored information; and
said access-giving or transmitter device is provided for giving access or transmitting different selected portions of said stored information at selected different repetition rates; and wherein
each one of said service providers has obtained an authorization provided voluntarily by each one of said users to access information regarding the driving by the user in return for providing the user with feedback regarding the driving by the user;
each one of said information regarding the driving by the user of the vehicle as sensed by a plurality of sensors mounted in the vehicle includes information regarding speed and acceleration of the vehicle, and said feedback includes information as to how to change the driving to obtain lower fuel consumption; and
at least one of said service providers is any of a driving training center, an emergency call center, a service workshop, a position-dependent information provider, or a vehicle manufacturer.

8. The method of claim 1 comprising the steps of:
receiving automatically, repeatedly and wirelessly from each one of a plurality of different users of transport vehicles information regarding the transport vehicle and the driving by the user of the transport vehicle as sensed by a plurality of sensors mounted in the transport vehicle, the information comprises operation properties and operation needs;
storing automatically and repeatedly each of said information regarding the transport vehicles and the driving of the transport vehicles in a database; and
giving access or transmitting to each one of said users a selected portion of each said automatically and repeatedly stored information regarding the other transport vehicles and the driving by the other users of transport vehicles, wherein
said selected portion comprises information to allow each one of said users to select a transport vehicle that, for the operation needs of that user, has optimum operation properties with regard to fuel consumption and vehicle wear and tear.

9. The method of claim 8 wherein
said information regarding the transport vehicles and the driving of the transport vehicles is processed;
operation properties are simulated based on received operation needs, and optionally on other information from the vehicles;
optimum operation properties with regard to fuel consumption and vehicle wear and tear are determined for each of the users of transport vehicles based on the operation needs of that user; and
the optimum operation properties for each of the users of transport vehicles are given access to or transmitted to that user.

10. The method of claim 8 wherein
said operation properties comprise a net moment matrix, gear ratios, gear, kind of engine, and kind of vehicle; and
said operation needs comprise moment, velocity, position, number of revolutions, fuel flow, and time.

11. The method of claim 1 comprising the steps of:
automatically and repeatedly receiving information from a transport vehicle, the information comprising velocity, accelerator pedal position, time, brake pedal position, driver identification, height level and position of the transport vehicle;
repeatedly calculating the cargo weight of the transport vehicle as a difference between the total weight of the transport vehicle and the weight of the transport vehicle itself, where the total weight of the transport vehicle is repeatedly determined from the information from the transport vehicle; and
repeatedly storing and/or informing the driver of the transport vehicle or other entity of the cargo weight.

12. The method of claim 11 wherein the total weight of the transport vehicle is repeatedly determined from potential energy and kinetic energy of the transport vehicle, energy change due to velocity change, and optionally roll and air resistance energy losses.

13. The method of claim 11 wherein the repeatedly measured cargo weight together with other data of the transport vehicle are processed statistically.

14. The method of claim 1 comprising the steps of:
automatically and repeatedly receiving information from a computer system of a transport vehicle, the information comprising velocity, accelerator pedal position, time, brake pedal position, driver identification, height level and position of the transport vehicle;
processing the information from the transport vehicle, the processing comprising to repeatedly calculate the time between acceleration is terminated and braking is started and to repeatedly calculate a driving planning capability parameter based on the calculated time between acceleration is terminated and braking is started; and
repeatedly storing and/or informing the driver of the transport vehicle or other entity of the repeatedly calculated driving planning capability parameter.

15. The method of claim 14 wherein the repeatedly calculated driving planning capability parameter is also based on other data such as e.g. height level and position of the transport vehicle.

16. The method of claim 14 wherein the repeatedly calculated driving planning capability parameter together with other data of the transport vehicle are processed statistically.

17. A method in a communication network for distributing transport vehicle driving information from a server connected in the communication network, wherein the steps of:
receiving automatically, repeatedly and wirelessly from each one of a plurality of different users of transport vehicles information regarding the transport vehicle and the driving by the user of the transport vehicle as sensed by a plurality of sensors mounted in the transport vehicle, the information comprises operation properties and operation needs;
storing automatically and repeatedly each of said information regarding the transport vehicles and the driving of the transport vehicles in a database; and
giving access or transmitting to each one of said users a selected portion of each said automatically and repeatedly stored information regarding the other transport vehicles and the driving by the other users of transport vehicles, wherein said selected portion comprises information to allow each one of said users to select a transport vehicle that, for the operation needs of that user, has optimum operation properties with regard to fuel consumption and vehicle wear and tear.

18. The method of claim 17 wherein
said information regarding the transport vehicles and the driving of the transport vehicles is processed;
operation properties are simulated based on received operation needs, and optionally on other information from the vehicles;
optimum operation properties with regard to fuel consumption and vehicle wear and tear are determined for each of the users of transport vehicles based on the operation needs of that user; and
the optimum operation properties for each of the users of transport vehicles are given access to or transmitted to that user.

19. The method of claim 17 wherein
said operation properties comprise a net moment matrix, gear ratios, gear, kind of engine, and kind of vehicle; and
said operation needs comprise moment, velocity, position, number of revolutions, fuel flow, and time.

20. A method for indicating the cargo weight of a transport vehicle, wherein the steps of:
automatically and repeatedly reading information from a computer system of a transport vehicle and optionally, by a sensor, measuring parameters not recorded by the computer system, the information and optional measured parameters comprising velocity, accelerator pedal position, time, brake pedal position, driver identification, height level and position of the transport vehicle;
processing the information and optional measured parameters, the processing comprising to repeatedly calculate the cargo weight of the transport vehicle as a difference between the total weight of the transport vehicle and the weight of the transport vehicle itself, and the total weight of the transport vehicle is repeatedly determined from the information and optional measured parameters; and
repeatedly storing and/or informing the driver of the transport vehicle or other entity of the cargo weight.

21. The method of claim 20 wherein the total weight of the transport vehicle is repeatedly determined from potential energy and kinetic energy of the transport vehicle, energy change due to velocity change, and optionally roll and air resistance energy losses.

22. The method of claim 20 wherein the repeatedly measured cargo weight together with other data of the vehicle are transmitted wirelessly to a central server system for storage and/or statistical processing.

23. A method for indicating the capability of planning the driving of a transport vehicle by a driver, wherein the steps of:
automatically and repeatedly reading information from a computer system of a transport vehicle and optionally, by a sensor, measuring parameters not recorded by the computer system, the information and optional measured parameters comprising velocity, accelerator pedal position, time, brake pedal position, driver identification, height level and position of the transport vehicle;
processing the information and optional measured parameters, the processing comprising to repeatedly calculate the time between acceleration is terminated and braking is started and to repeatedly calculate a driving planning capability parameter based on the calculated time between acceleration is terminated and braking is started; and
repeatedly storing and/or informing the driver of the transport vehicle or other entity of the repeatedly calculated driving planning capability parameter.

24. The method of claim 23 wherein the repeatedly calculated driving planning capability parameter is also based on other data such as e.g. height level and position of the transport vehicle.

25. The method of claim 23 wherein the repeatedly calculated driving planning capability parameter together with other data of the vehicle are transmitted wirelessly to a central server system for storage and/or statistical processing.

26. The method of claim 1 wherein at least one of said service providers is an insurance company.

27. The method of claim 1 wherein at least two of said service providers are each any of an insurance company, a driving training center, an emergency call center, an alarm central, a vehicle manufacturer, a service workshop, a position-dependent information provider, a leasing or rental company, a road department, or the police.

28. The server system of claim 7 wherein at least one of said service providers is an insurance company.
